(19) United States
(12) Patent Application Publication
(10) Pub. No.: US 2020/0144783 A1
(43) Pub. Date: May 7, 2020

(54) MECHANICAL Q-SWITCH

(71) Applicant: BAE Systems Information and Electronic Systems Integration Inc., Nashua, NH (US)

(72) Inventors: Michael J. Choiniere, Merrimack, NH (US); Egor V. Degtiarev, Merrimack, NH (US)

(73) Assignee: BAE Systems Information and Electronic Systems Integration Inc., Nashua, NH (US)

(21) Appl. No.: 16/616,170

(22) PCT Filed: May 25, 2017
(86) PCT No.: PCT/US2017/034479

§ 371 Date: Nov. 22, 2019

(51) Int. Cl. H01S 3/121

(52) U.S. Cl. CPC H01S 3/121; H01S 3/0602

(57) ABSTRACT

A mechanical Q-switch for use with lasers. The Q-switch has a spinning disk mounted to a motor. The disk has a slot notched out of the disk. In some cases, the slot is located on the perimeter of the disk. In other cases, the slot is spaced away from the perimeter of the disk. The slot rotates through the focal point of the laser to provide Q-switching capability. In some cases, the disk is translated in a first direction or a second direction to intercept the focal point with the slot to provide Q-switching capability. The mechanical Q-switch is added onto a pre-aligned optical bench and provides very inexpensive and very fast switching,

### FIELD OF THE DISCLOSURE

The present disclosure relates to lasers and laser range finders, and more particularly to reliable and inexpensive Q-switches for lasers and laser range finders.

### BACKGROUND OF THE DISCLOSURE

Mechanical Q-stitches used in lasers typically rotate a mirror to complete the alignment of the mirrors within the lasers. This has both alignment and complexity issues that drive the cost up for the system and also reduce the reliability of the switching. Wherefore it is an object of the present disclosure to overcome the above mentioned shortcomings and drawbacks associated with the prior art Q-switches.

### SUMMARY OF THE DISCLOSURE

One aspect of the present disclosure is a mechanical Q-switch comprising a disk having a slot notched out of the disk; and a motor for rotating the disk about an axis such that the slot in the disk rotates through a focal point of a laser and provides Q-switching capability.

In certain embodiments, the slot is located on a perimeter of the disk and in other embodiments the slot is spaced away from a perimeter of the disk. In some cases, the slot has a width of about 20 μm.

In another embodiment of the Q-switch, the disk has a diameter of about 1 inch. In some cases, the motor is configured to translate the disk in a first and a second direction to align the slot in the disk with the focal point of the laser as the disk is rotated about the axis.

Another aspect of the present disclosure is a laser range finder having a mechanical Q-switch comprising a laser light source producing an output laser beam; at least one lens for focusing the output laser beam at a focal point; a detector for detecting an input beam created when the output beam is reflected off a target surface; and a mechanical Q-switch comprising, a disk having a slot notched out of the disk; and a motor for rotating the disk about an axis such that the slot in the disk rotates through the focal point of the output laser beam providing Q-switching capability.

In certain embodiments, the slot is located on a perimeter of the disk and in other embodiments the slot is spaced away from a perimeter of the disk. In some cases, the slot has a width of about 20 μm.

In another embodiment of the laser range finder, the disk has a diameter of about 1 inch. In some cases, the motor is configured to translate the disk in a first and a second direction to align the slot in the disk with the focal point of the laser as the disk is rotated about the axis.

Yet another aspect of the present disclosure is a method of modulating a pulsed laser comprising, providing a laser light source; generating a laser beam via the laser light source; focusing the laser beam to a focal point using one or more lenses; providing a disk, where the disk has a slot in the disk; mounting the disk to a motor; rotating the disk about an axis; and aligning the disk such that the slot in the disk will intercept the focal point of the laser beam when rotated about the axis to provide a pulsed laser beam.

In certain embodiments, the slot is located on a perimeter of the disk and in other embodiments the slot is spaced away from a perimeter of the disk. In some cases, the slot has a width of about 20 Lm.

In another embodiment of the method of modulating a pulsed laser, the disk has a diameter of about 1 inch. In some cases, the motor is configured to translate the disk in a first and a second direction to align the slot in the disk with the focal point of the laser as the disk is rotated about the axis.

In yet another embodiment of the method of modulating a pulsed laser, aligning the slot in the disk with the focal point of the laser as the disk is rotated about the axis further comprises translating the slot in a first direction or a second direction to intercept the focal point of the laser beam.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows one embodiment of the mechanical Q-switch for use with lasers according to the principles of the present disclosure.

FIG. 2A shows one embodiment of the disk of the mechanical Q-switch for use with lasers according to the principles of the present disclosure.

FIG. 2B shows another embodiment of the disk of the mechanical Q-switch for use with lasers according to the principles of the present disclosure.

FIG. 3 shows one embodiment of the mechanical Q-switch of the present disclosure as used in a laser range finder.

### DETAILED DESCRIPTION OF THE DISCLOSURE

Conventional systems that use spinning end mirrors for laser alignment make the motor and the spinning mirror part of the alignment process of the laser. That method increases the complexity of the alignment process and lowers the reliability of the alignment process at the same time.

In contrast, the system of the present disclosure allows for the laser to be aligned on an optical bench with no regard to the q-switch. A long pulse is used for verification. All of the optical components in the laser system are bonded and aligned. The motor and the spinning disk are simply mounted adjacent to the optical bench. This provides for a system where the spinning “slot” in the disk transitions through the focal point of the laser system to provide the q-switch function.

Other benefits of the system are that there is no pre-lase condition since the system acts as a hard switch until “open.” There is no material variability as in other passive optical materials, no loss due to the use of a passive q-switch material, and there is a much lower system cost than when using a passive q-switch material.

By using a set of fiber optic collimating lenses (very cost effective, a few dollars) the beam within the laser is focused to a fine point. This allows a mechanical spinning disk with a slot having a width of about 20 μm and spinning at about 300 Hz to transition the focus area from “open” to “closed” providing a Q-switch capability. In certain embodiments, the spinning disk is about 1 inch in diameter. The slot width can vary, but generally ranges from about 10 μm to about 40 μm.

In some cases this system is used on smaller lasers, including lasers under 50 mJ. The switch times can vary, but can be in the microsecond range. In other embodiments, the switching times can be in the nanosecond range by using sharp focusing lens (focus <25 um). The disk materials range from metals to etched patterns on optical glass.

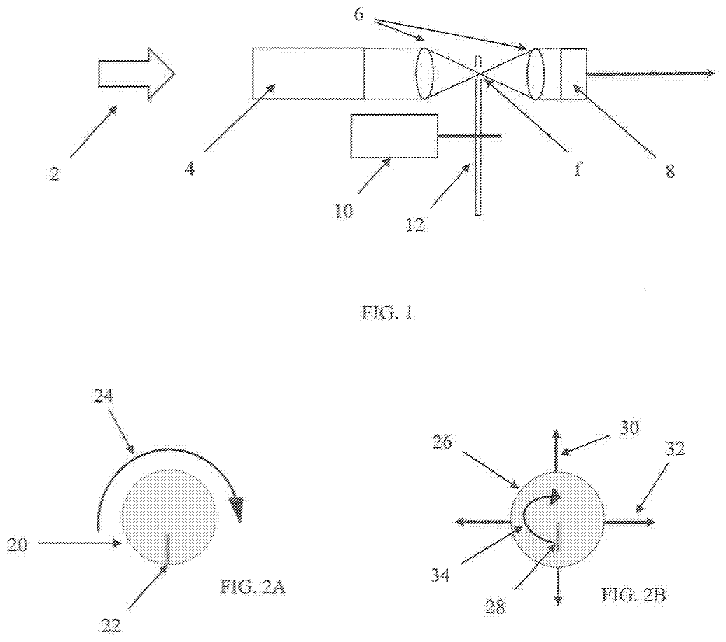

Referring to FIG. 1, the laser system can be end pumped 2 using standard methods into a gain medium 4. In some cases, fiber optic lens elements 6 are used with an output coupler 8. The bam is focused to a fine point using lenses. A motor 10 is used to spin the slotted disk 12 to provide the q-switch capability. As the slot (see, FIG. 2A or 2B) is rated through the focal point, f, the switch is “on.” When the disk is blocking the beam the switch is “off.” In certain embodiments, the motor and spinning disk are not part of the laser alignment step. Instead, the laser can be aligned in long pulse mode and the Q-switch is added after with no hold-off penalty.

As noted above, previous techniques depend on rotating one of the end mirrors into alignment and this introduces beam stability issues. To mitigate the stability issues, a poro-prism is often added to nullify the tolerance in the non spinning axis, but this adds complexity and additional cost to the system.

In contrast, the approach of the present disclosure focuses the laser's internal beam to a fine point which the rotating slot rotates through. This method minimizes the transition time between “on” and “off” through the beam by >30:1. This method also mitigates any issues with double pulsing within that transition time. This approach provides the same transition time as a rotatory mirror approach without the alignment/complexity issues. In some cases, this approach provides near immediate “on” and mostly “off.”

Referring to FIG. 2A, one embodiment of the disk of the mechanical Q-switch for use with lasers according to the principles of the present disclosure. More specifically, a disk 20 is shown having a slot 22 notched into the perimeter of the disk. The disk is mounted to a motor (as in FIG. 1) and is rotated 24 such that the slot 22 in the disk 20 rotates through the focal point of the laser system.

Referring to FIG. 2B, another embodiment of the disk of the mechanical Q-switch for use with lasers according to the principles of the present disclosure. More specifically, a disk 26 is shown with a slot 28 notched out of the disk. Here, the slot is spaced away from the perimeter of the disk. The disk is mounted to a motor (as in FIG. 1) and is rotated 34 such that the slot 28 in the disk 26 rotates through the focal point of the laser system when the slot is aligned to intersect the focal point. The motor can also translate the disk in a first direction 30 and translate the disk in a second direction 32 to provide additional approaches to control the Q switching capacity of the system. The first direction is perpendicular to the second direction.

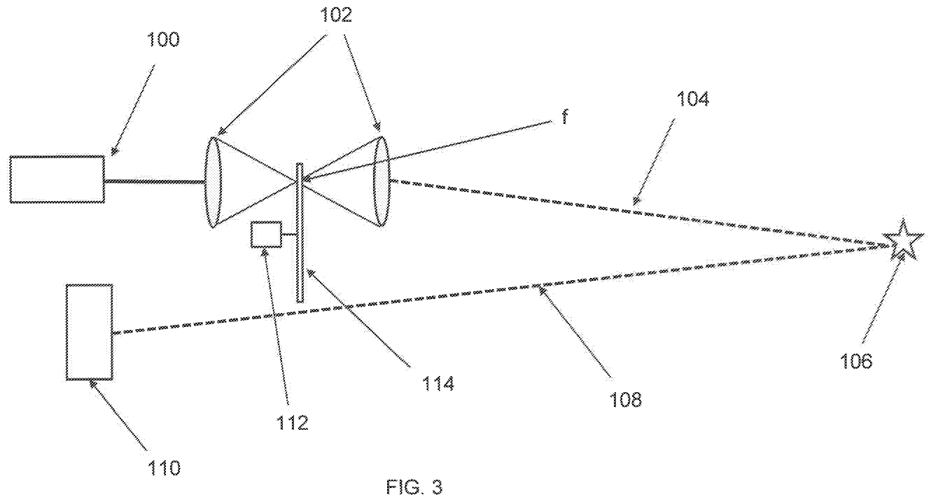

Referring to FIG. 3, one embodiment of the mechanical Q-switch of the present disclosure as used in a laser range finder is shown. More specifically, a laser light source 100 is focused to a focal point f using at least one lens 102, here a pair is used. Using the mechanical Q-switch of the present disclosure, a pulsed beam 104 is produced. By pointing the pulsed beam at a target 106 a reflected beam 108 can be detected by a detector 110 and provide distance information. The mechanical Q-switch comprises at least a motor 112 for rotating a disk 114 about an axis. The disk has a slot located in the disk that is aligned to intercept with the focal point f to provide Q-switching capability. The slot can vary in size and location and the rotation speed of the disk can also vary. Additionally, the disk may also be translated in and out of position to provide additional variation in the “on” and “off” periodicity.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including.” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A mechanical Q-switch comprising
a disk having a slot notched out of the disk; and
a motor for rotating the disk about an axis such that the slot in the disk rotates through a focal point of a laser and provides Q-switching capability.

2. The mechanical Q-switch of claim 1, wherein the slot is located on a perimeter of the disk.

3. The mechanical Q-switch of claim 1, wherein the slot is spaced away from a perimeter of the disk.

4. The mechanical Q-switch of claim 1, wherein the slot has a width of about 20 μm.

5. The mechanical Q-switch of claim 1, wherein the disk has a diameter of about 1 inch.

6. The mechanical Q-switch of claim 3, wherein the motor is configured to translate the disk in a first and a second direction to align the slot in the disk with the focal point of the laser as the disk is rotated about the axis.

7. A laser range finder having a mechanical Q-switch comprising
a laser light source producing an output laser beam;
at least one lens for focusing the output laser beam at a focal point;
a detector for detecting an input beam created when the output beam is reflected off a target surface; and
a mechanical Q-switch comprising,
a disk having a slot notched out of the disk; and
a motor for rotating the disk about an axis such that the slot in the disk rotates through the focal point of the output laser beam providing Q-switching capability.

8. The laser range finder having a mechanical Q-switch of claim 7, wherein the slot is located on a perimeter of the disk.

9. The laser range finder having a mechanical Q-switch of claim 7, wherein the slot is spaced away from a perimeter of the disk.

10. The laser range finder having a mechanical Q-switch of claim 7, wherein the slot has a width of about 20 μm.

11. The laser range finder having a mechanical Q-switch of claim 7, wherein the disk has a diameter of about 1 inch.

12. The laser range finder having a mechanical Q-switch of claim 9, wherein the motor is configured to translate the disk in a first and a second direction to align the slot in the disk with the focal point of the laser as the disk is rotated about the axis.

13. A method of modulating a pulsed laser comprising, providing a laser light source;
generating a laser beam via the laser light source;
focusing the laser beam to a focal point using one or more lenses;
providing a disk, where the disk has a slot in the disk;
mounting the disk to a motor;
rotating the disk about an axis; and
aligning the disk such that the slot in the disk will intercept the focal point of the laser beam when rotated about the axis to provide a pulsed laser beam.

14. The method of modulating a pulsed laser of claim 13, wherein the slot is located on a perimeter of the disk.

15. The method of modulating a pulsed laser of claim 13, wherein the slot is spaced away from a perimeter of the disk.

16. The method of modulating a pulsed laser of claim 13, wherein the slot has a width of about 20 μm.

17. The method of modulating a pulsed laser of claim 13, wherein the disk has a diameter of about 1 inch.

18. The method of modulating a pulsed laser of claim 15, further comprising translating the disk in a first and a second direction using the motor.

19. The method of modulating a pulsed laser of claim 18, wherein aligning the slot in the disk with the focal point of the laser as the disk is rotated about the axis further comprises translating the slot in a first direction or a second direction to intercept the focal point of the laser beam.
